(19) United States
(12) Patent Application Publication
(10) Pub. No.: US 2024/0419139 A1
(43) Pub. Date: Dec. 19, 2024

(54) RECORDING MEDIUM, SIMULATION DEVICE, AND CONTROL METHOD

(71) Applicant: Mitsubishi Electric Corporation, Tokyo (JP)

(72) Inventors: Masamitsu HATTORI, Tokyo (JP); Atsuo HAISHI, Tokyo (JP); Ko KOSAKA, Tokyo (JP); Masaya KIMURA, Tokyo (JP); Kyosuke ASAKI, Tokyo (JP)

(73) Assignee: Mitsubishi Electric Corporation, Tokyo (JP)

(21) Appl. No.: 18/723,941

(22) PCT Filed: Apr. 18, 2022
(86) PCT No.: PCT/JP2022/018042

§ 371 Date: Jun. 25, 2024

(51) Int. Cl. G05B 17/02

(52) U.S. Cl. CPC G05B 17/02

(57) ABSTRACT

A simulation program is installed on an engineering setting tool. A controller control simulator simulates control performed by a controller by executing a controller program. A machine operation simulator simulates an operation of a machine using a machine model being a model of the machine in a library file format.

### TECHNICAL FIELD

The present disclosure relates to a simulation program, a simulation device, and a control method.

### BACKGROUND ART

The operation of a user system that is a factory automation (FA) system to which multiple types of FA devices are connected is verified by simulating the operations of the FA devices with an engineering setting tool. The engineering setting tool is implemented by executing software on a computer such as a personal computer. The engineering setting tool can provide a user interface to a user to support the user creating a user program and activate a simulator that simulates the operations of the FA devices described above.

For the above user system including a controller to control the FA devices, the engineering setting tool can activate the simulator that executes the user program for the controller. The engineering setting tool can thus simulate the operations of the FA devices while simulating the control performed by the controller. The engineering setting tool thus allows examination, for example, to determine whether the controller correctly performs processing such as setting execution conditions of the user program, setting execution start and stop, performing data processing, or calculating the positions to which the axes of the FA devices move.

Patent Literature 1 describes a simulation performed by a cell controller in a sheet-metal processing automation system, although the simulation is not performed by a computer such as an engineering setting tool different from a controller. The cell controller described in Patent Literature 1 is a computer connected to a machine included in a sheet-metal processing line for manufacturing products from sheet metal to control the sheet-metal processing line. To simulate the operation on the sheet-metal processing line, a sheet-metal processing line model is installed on the cell controller described in Patent Literature 1. The sheet-metal processing line model is generated by a computer-aided design and a computer-aided manufacturing (CAD/CAM) system connected to the cell controller.

### CITATION LIST

### Patent Literature

Patent Literature 1: Unexamined Japanese Patent Application Publication No. 2003-108212

### SUMMARY OF INVENTION

### Technical Problem

The cell controller described in Patent Literature 1 relies on a device in a dedicated CAD/CAM system included in the sheet-metal processing automation system to simulate the operation on the sheet-metal processing line.

Under such circumstances, an objective of the present disclosure is to simulate control performed by a controller and an operation of a machine without relying on a device that generates a model of the machine controlled by the controller.

### Solution to Problem

To achieve the above objective, a simulation program according to an aspect of the present disclosure is a program for causing a simulation device for simulating control on a machine performed by a controller to function as a controller control simulator to simulate control performed by the controller by executing a program for the controller and a machine operation simulator to simulate an operation of the machine using a machine model being a model of the machine in a library file format.

### Advantageous Effects of Invention

In the structure according to the above aspect of the present disclosure, the machine operation simulator simulates the operation of a machine using a machine model being a model in a library file format. Thus, the simulation program according to the above aspect of the present disclosure can simulate control performed by the controller and the operation of the machine without relying on a device that generates a model of the machine controlled by the controller.

### BRIEF DESCRIPTION OF DRAWINGS

FIG. 1 is a diagram of an entire user system in Embodiment 1;

FIG. 2 is a functional block diagram of an engineering setting tool according to Embodiment 1;

FIG. 3 is a block diagram of the engineering setting tool according to Embodiment 1, illustrating the hardware configuration;

FIG. 4 is a diagram of a first example display of a machine model allocation screen in Embodiment 1;

FIG. 5 is a diagram of a second example display of a machine model allocation screen in Embodiment 1;

FIG. 6 is a diagram of a third example display of a machine model allocation screen in Embodiment 1;

FIG. 7 is a diagram illustrating a simulation of an operation of a machine in Embodiment 1;

FIG. 8 is a flowchart of a process of outputting a simulation result in Embodiment 1;

FIG. 9 is a flowchart of a simulation process in Embodiment 1;

FIG. 10 is a diagram illustrating a simulation of an operation of a machine in Embodiment 2; and

FIG. 11 is a diagram of an example display of a machine model allocation screen in Embodiment 3.

### DESCRIPTION OF EMBODIMENTS

A simulation program, a simulation device, and a control method according to one or more embodiments of the present disclosure are described below in detail with reference to the drawings. In the drawings, the same reference signs denote the same or equivalent components.

### Embodiment 1

### User System 1 in Embodiment 1

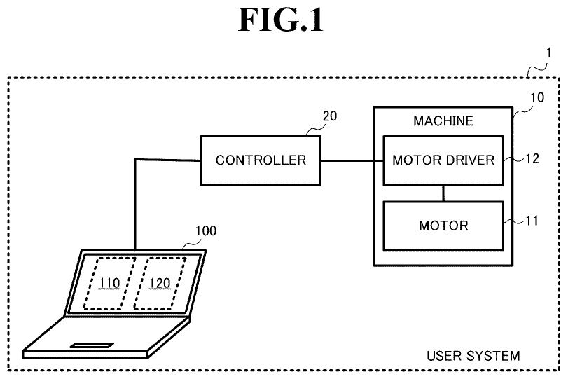

A user system 1 in Embodiment 1 of the present disclosure is, for example, a factory automation (FA) system built by a user. As illustrated in FIG. 1, the user system 1 includes a machine 10 that performs operations and a controller 20 connected to the machine 10 to control the machine 10. The user system 1 also includes an engineering setting tool 100 that is an example of a simulation device connected to the controller 20 to simulate control on the machine 10 performed by the controller 20.

### Machine 10 in Embodiment 1

The machine 10 is, for example, an FA device. The machine 10 includes a motor 11 installed on each axis of the machine 10 and a motor driver 12 that drives the motor 11.

### Controller 20 in Embodiment 1

The controller 20 is a computer such as a programmable logic controller (PLC), an industrial personal computer, or a servo system controller. The controller 20 controls the motor driver 12 to control driving of the motor 11.

### Engineering Setting Tool 100 According to Embodiment 1

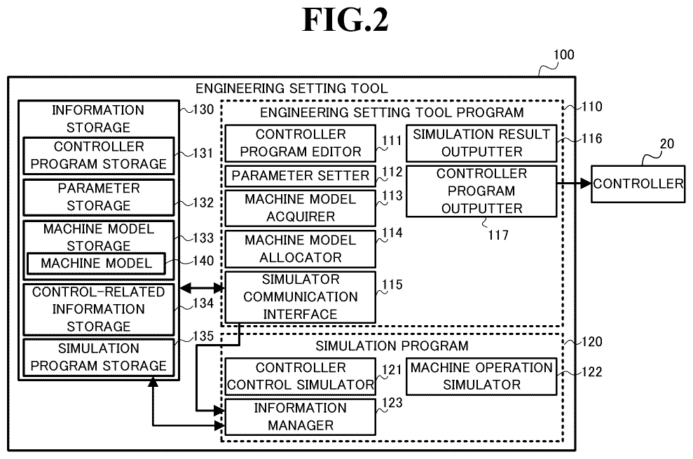

As illustrated in FIG. 2, the engineering setting tool 100 is a computer on which an engineering setting tool program 110 is installed. The engineering setting tool program 110 is a program to implement the function as a setting tool usable by a user as an engineer. More specifically, the engineering setting tool 100 is, for example, a laptop personal computer carried by a user or a tablet personal computer on which the engineering setting tool program 110 is installed. A simulation program 120 is also installed on the engineering setting tool 100 to implement the function as a simulator to simulate control on the machine 10 performed by the controller 20.

The engineering setting tool 100 generates, based on a user input, a source code of a controller program that is a program for the controller 20. The engineering setting tool 100 also compiles the controller program to convert the program to an object code that is data in a form executable by the controller 20. The controller program is, for example, a program for the controller 20 to perform calculation for positioning the machine 10 and control the output of an instruction on the position of the machine 10.

The engineering setting tool 100 is connected to the controller 20 with, for example, a cable complying with universal serial bus (USB) standard. The engineering setting tool 100 can thus transmit the controller program converted to the object code to the controller 20 and cause the controller program to be stored into a memory (not illustrated) included in the controller 20. The controller 20 can thus execute the controller program with the object code stored in the memory and can perform, for example, calculation for positioning the machine 10 or control the output of an instruction on the position of the machine 10.

The engineering setting tool 100 includes a controller program editor 111 that edits the controller program and a parameter setter 112 that sets parameters for the simulation. The engineering setting tool 100 further includes a machine model acquirer 113 that acquires a machine model 140 that is a model of the machine 10 and a machine model allocator 114 that allocates the machine model 140 to a state variable of the machine 10 used in the controller program. The engineering setting tool 100 further includes a simulator communication interface 115 that transmits and receives information with the simulator based on the simulation program 120. The engineering setting tool 100 further includes a simulation result outputter 116 that outputs simulation result information indicating the simulation results and a controller program outputter 117 that outputs the controller program to the controller 20.

As indicated by the upper dotted frame in FIG. 2, the controller program editor 111, the parameter setter 112, the machine model acquirer 113, the machine model allocator 114, the simulator communication interface 115, the simulation result outputter 116, and the controller program outputter 117 are implementable by, for example, the engineering setting tool program 110 installed on the engineering setting tool 100.

The engineering setting tool 100 further includes a controller control simulator 121 that simulates control performed by the controller, and a machine operation simulator 122 that simulates the operation of the machine 10. The engineering setting tool 100 further includes an information manager 123 that manages information about the simulations.

As indicated by the lower dotted frame in FIG. 2, the controller control simulator 121, the machine operation simulator 122, and the information manager 123 together serve as a simulator implementable by, for example, the simulation program 120 installed on the engineering setting tool 100.

The engineering setting tool 100 further includes an information storage 130 storing information. The information storage 130 includes a controller program storage 131 storing the controller program, a parameter storage 132 storing parameters for simulations, and a machine model storage 133 storing the machine model 140. The information storage 130 further includes a control-related information storage 134 storing control-related information about the control performed by the controller 20, and a simulation program storage 135 storing the simulation program 120.

### Hardware Configuration of Engineering Setting Tool 100 According to Embodiment 1

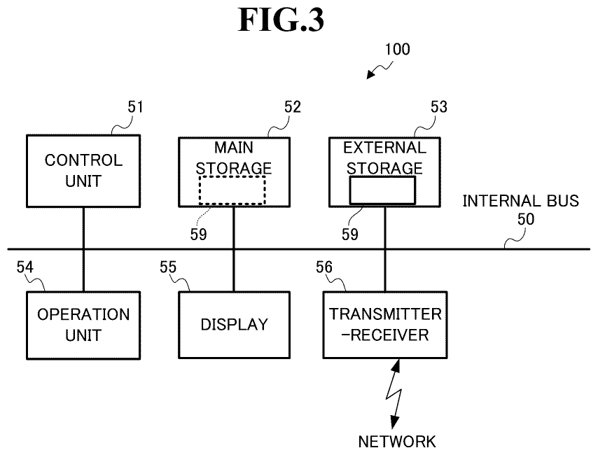

As illustrated in FIG. 3, the engineering setting tool 100 includes a control unit 51 that performs processing in accordance with a control program 59 such as a simulation program. The control unit 51 includes a central processing unit (CPU). The control unit 51 functions as, in accordance with the control program 59, the controller program editor 111, the parameter setter 112, the machine model allocator 114, the simulator communication interface 115, the simulation result outputter 116, the controller control simulator 121, the machine operation simulator 122, and the information manager 123 illustrated in FIG. 2.

Referring back to FIG. 3, the engineering setting tool 100 includes a main storage 52 into which the control program 59 is loaded. The main storage 52 is used as a work area for the control unit 51. The main storage 52 includes a random-access memory (RAM).

Referring back to FIG. 3, the engineering setting tool 100 includes an external storage 53 that prestores the control program 59. As instructed by the control unit 51, the external storage 53 provides data stored in the program to the control unit 51 and stores data provided from the control unit 51. The external storage 53 includes a volatile or nonvolatile semiconductor memory such as a read-only memory (ROM), a flash memory, an erasable programmable ROM (EPROM), or an electrically erasable programmable ROM (EEPROM), or a nonvolatile, non-transitory recording medium such as a magnetic disk, a flexible disk, an optical disk, a compact disc, a MiniDisc, a digital versatile disc (DVD), a hard disk drive (HDD), or a solid-state drive (SSD). The external storage 53 functions as the information storage 130 illustrated in FIG. 2.

Referring back to FIG. 3, the engineering setting tool 100 includes an operation unit 54 operable by the user. Information input with the operation unit 54 is provided to the control unit 51. The operation unit 54 includes information input components such as a keyboard, a mouse, and a touch screen.

The engineering setting tool 100 further includes a display 55 that displays information input with the operation unit 54 and information output by the control unit 51. The display 55 includes a display device such as a liquid crystal display (LCD) or an organic light-emitting diode (OLED) display.

The engineering setting tool 100 includes a transmitter-receiver 56 that transmits and receives information. The transmitter-receiver 56 includes information communication components such as a communication network terminal connected to a network or a radio communication device. The transmitter-receiver 56 functions as the machine model acquirer 113 and the controller program outputter 117 illustrated in FIG. 2.

Referring back to FIG. 3, the main storage 52, the external storage 53, the operation unit 54, the display 55, and the transmitter-receiver 56 in the engineering setting tool 100 are connected to the control unit 51 with an internal bus 50.

The engineering setting tool 100 implements the functions of the components 111 to 117, 121 to 123, and 130 illustrated in FIG. 2 with the control unit 51 using the main storage 52, the external storage 53, the operation unit 54, the display 55, and the transmitter-receiver 56 as resources. The engineering setting tool 100 performs, for example, controller program editing with the controller program editor 111, parameter setting with the parameter setter 112, machine model allocation with the machine model allocator 114, and simulator communication with the simulator communication interface 115.

The engineering setting tool 100 performs, for example, simulation result output with the simulation result outputter 116, controller program output with the controller program outputter 117, controller control simulation with the controller control simulator 121, machine operation simulation with the machine operation simulator 122, information management with the information manager 123, and information storage with the information storage 130.

Details of Functional Components of Engineering Setting Tool 100 According to Embodiment 1

Referring back to FIG. 2, the controller program editor 111 causes the display 55 to display a program editing screen (not illustrated) that is a user interface for the user to create the controller program. The controller program editor 111 edits the source code of the controller program based on a user input into the program editing screen with the operation unit 54.

The parameter setter 112 sets, for example, as a parameter, a setting value for a control calculation cycle that is a calculation cycle for the control performed by the controller 20 in a simulation performed by the controller control simulator 121. The parameter setter 112 sets, for example, as a parameter, a setting value for an operation calculation cycle that is a calculation cycle for the operation of the machine 10 in a simulation performed by the machine operation simulator 122. The parameter setter 112 causes the display 55 to display a parameter setting screen (not illustrated) that is a user interface for setting these parameters. The parameter setter 112 sets these parameters based on user inputs into the parameter setting screen with the operation unit 54. When setting the setting value for the control calculation cycle, the parameter setter 112 automatically sets the setting value for the operation calculation cycle to the same value as the setting value for the control calculation cycle, such as 4 ms.

The machine model acquirer 113 receives, from a device external to the user system 1, the machine model 140 generated by the external device to acquire the machine model 140. In the present embodiment, the external device that transmits the machine model 140 generates the machine model 140. In some embodiments, the machine model 140 generated by a device external to the user system 1 may be transmitted by another external device. In the present embodiment, the machine model acquirer 113 acquires the machine model 140 from a device external to the user system 1. In some embodiments, the machine model acquirer 113 may acquire the machine model 140 generated by, for example, the engineering setting tool 100.

The machine model 140 is a mathematical, logical model of a dynamic system of the machine 10, or more specifically, software including the definitions of the model structure of the machine 10 and the implementation of the function representing the operation of the model of the machine 10. The definitions of the model structure of the machine 10 include, for example, inputs, outputs, parameters, and other variables of the machine 10. The operation of the model of the machine 10 can be expressed in an equation of motion to calculate the state change of the modeled dynamic system over time.

In the present embodiment, the definitions of the model structure of the machine 10 is described in an extensible markup language (XML) file format as an example markup language that is a formal language to describe text, the meaning of data, and the structure. The function representing the operation of the machine 10 is implemented in a file format of a binary file such as a dll file in a dynamic-link library (DLL) or a Windows (registered trademark) operating system (OS). In other words, the machine model 140 is a mathematical, logical model of the machine 10 in the format of a general-purpose library file such as an XML file or a dll file.

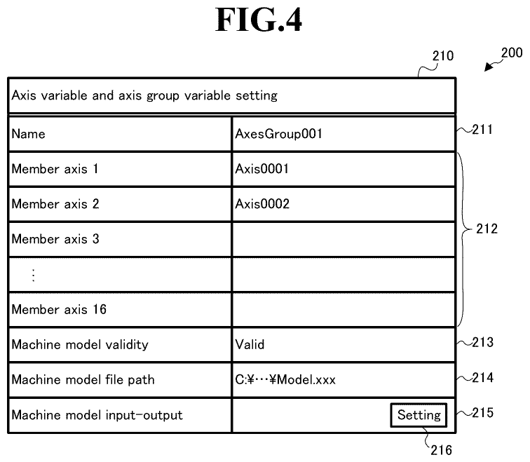

The machine model allocator 114 allocates the machine model 140 to an axis variable that is a state variable of an axis for operation of the machine 10 and to an axis group variable that is a state variable of a group of multiple types of axes associated with one another. The machine model allocator 114 causes the display 55 to display a machine model allocation screen 200 illustrated in FIGS. 4 to 6 that is a user interface for allocating the machine model 140 to these state variables. The machine model allocator 114 allocates the machine model 140 to these state variables based on user inputs into the machine model allocation screen 200 with the operation unit 54.

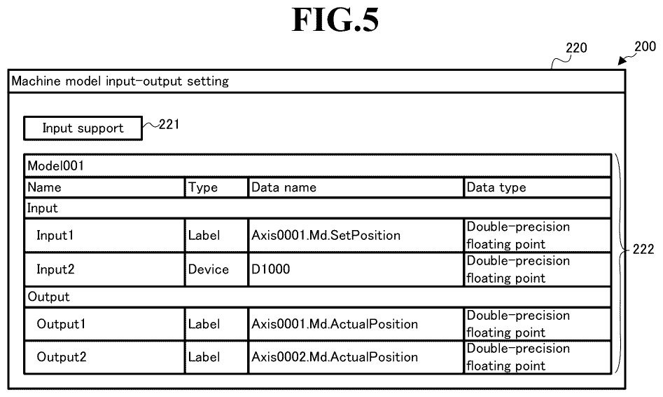

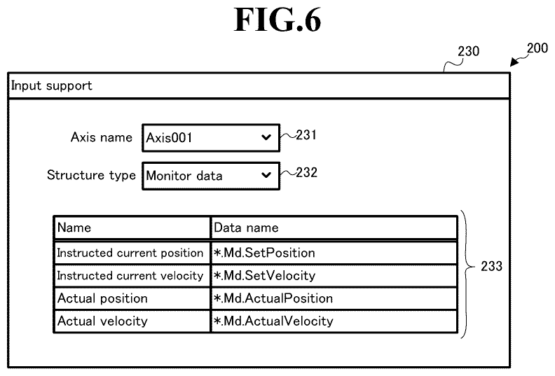

The machine model allocation screen 200 includes a state variable setting screen 210 illustrated in FIG. 4 for setting the state variable of the machine 10. The machine model allocation screen 200 further includes a machine model input-output setting screen 220 illustrated in FIG. 5 for detailed setting of inputs and outputs into and from the machine model 140 and an input-output setting support screen 230 illustrated in FIG. 6 for supporting setting of inputs and outputs into and from the machine model 140.

The machine model allocator 114 first displays the state variable setting screen 210 illustrated in FIG. 4 as the machine model allocation screen 200. As illustrated in FIG. 4, the state variable setting screen 210 includes, in descending order, an axis name display section 211 for displaying the name of an axis or an axis group, a member display section 212 for displaying the members of an axis group, a validity setting section 213 for setting the validity of the machine model 140, a file path setting section 214 for setting the file path of the machine model 140, and an input-output setting section 215 for setting inputs and outputs into and from the machine model 140. The input-output setting section 215 includes a setting button 216 to be pressed by the user.

The axis name display section 211 displays, for example, AxesGroup001 that is the name of an axis group for the Name field. The member display section 212 displays, for the Member axis 1 field, for example, Axis001 that is the name of a first member axis in the axis group. The validity setting section 213 displays, for the Machine model validity field, for example, Valid, set through a user input with the operation unit 54. In this case, the user inputs into the file path setting section 214 and the input-output setting section 215 with the operation unit 54 are valid.

The file path setting section 214 thus displays, for the Machine model file path field, for example, C: \ . . . \Model001.xxx, set through a user input with the operation unit 54. When the user presses the setting button 216 in the input-output setting section 215 through an input with the operation unit 54, the machine model allocator 114 displays the machine model input-output setting screen 220 in FIG. 5.

As illustrated in FIG. 5, the machine model input-output setting screen 220 includes, in an upper portion, an input support button 221 to be pressed by the user and an input-output setting section 222 in a table form in a lower portion for detailed setting of the inputs and outputs into and from the machine model 140.

The input-output setting section 222 displays, for each input and each output, the information for the Name field indicating the name of the input or the output into or from the machine model 140, the Type field indicating the type of the input or the output, the Data name field indicating the name of the axis variable or the axis group variable corresponding to the input or the output, and the Data type field indicating the data type of the input or the output. The input-output setting section 222 displays, for example, for the input with the name Input1 of the machine model 140 being Model001, the type being a label, the data name being Axis0001.Md.SetPosition, and the data type being a double-precision floating point format. The input-output setting section 222 further displays, for example, for the output with the name Output1, the type being a label, the data name being Axis0001.Md.ActualPosition, and the data type being a double-precision floating point format.

The user can set, for each input or each output into or from the machine model 140, information for the fields in the input-output setting section 222 through an input with the operation unit 54. When the user presses the input support button 221 with either the input or output row in the input-output setting section 222 being selected through an input with the operation unit 54, the machine model allocator 114 displays the input-output setting support screen 230 illustrated in FIG. 6.

As illustrated in FIG. 6, the input-output setting support screen 230 includes, in descending order, an axis name selection section 231 for selecting the name of an axis or an axis group, a structure type selection section 232 for selecting the type of structure of an axis variable or an axis group variable, and a data name selection section 233 for selecting the data name of the axis variable or the axis group variable.

The axis name selection section 231 and the structure type selection section 232 are pull-down menus. When the user presses the axis name selection section 231 through an input with the operation unit 54, the user can select the name of the axis or the axis group associated with the machine model 140 through allocation, or more specifically, can select any of AxesGroup001, Axis0001, and Axis0002 illustrated in FIG. 4. The axis name selection section 231 thus displays, for example, Axis0001 selected for the Axis name field.

In this state, when the user presses the structure type selection section 232 through an input with the operation unit 54, the user can select the type of the structure that is an example data format in the axis variable with the name Axis0001 selected in the axis name selection section 231, or for example, can select any of types including parameter data and monitor data. The structure type selection section 232 thus displays, for example, Monitor data, set for the Structure type field.

In this case, the data name selection section 233 displays the data name of the axis variable or the axis group variable narrowed down by the axis or the axis group selected in the axis name selection section 231 and the type of the structure selected in the structure type selection section 232. The data name selection section 233 displays, for the Name field, for example, Instructed current position indicating the description of the axis variable or the axis group variable, and for the Data name field, *.Md.SetPosition indicating the data name of the axis variable or the axis group variable.

In this state, when the user selects the data name of the axis variable or the axis group variable displayed on the data name selection section 233 through an input with the operation unit 54, the machine model allocator 114 ends displaying the input-output setting support screen 230, and automatically sets information corresponding to the Type field, Data name field, and Data type field into the input row or the output row selected in the machine model input-output setting screen 220 in FIG. 5.

In a specific example, the user presses the input support button 221 with the input row Input1 in the input-output setting section 222 being selected in the machine model input-output setting screen 220 in FIG. 5, and selects, in the input-output setting support screen 230 in FIG. 6, Axis0001 in the axis name selection section 231, Monitor data in the structure type selection section 232, and *.Md.SetPosition in the data name selection section 233. In this case, the machine model allocator 114 automatically displays, on the machine model input-output setting screen 220 in FIG. 5, Label for the Type field in the input row Input1 in the input-output setting section 222, Axis0001.Md.SetPosition for the Data name field, and Double-precision floating point for the Data type field to automatically set these pieces of information. The machine model allocator 114 can thus allocate the machine model 140 to the axis variable or the axis group variable.

Referring back to FIG. 2, the simulator communication interface 115 starts execution of the simulation program 120 to activate the simulator. The simulator communication interface 115 transmits a controller program, information indicating parameters, and information about the machine model 140 and allocation to the simulator. After the simulator performs the simulation, the simulator communication interface 115 acquires simulation result information from the simulator.

The simulation result outputter 116 causes the display 55 to display the simulation result information (not illustrated) received by the simulator communication interface 115 to output simulation result information.

The controller program outputter 117 transmits, to the controller 20, the controller program having the source code edited based on the simulation results and converted to the object code to output the controller program.

The information manager 123 receives information transmitted from the simulator communication interface 115 and causes the information storage 130 to store the information. More specifically, the information manager 123 causes the controller program storage 131 to store the acquired controller program, causes the parameter storage 132 to store the information indicating the acquired parameter, and causes the machine model storage 133 to store information about the acquired machine model 140 and allocation. The information manager 123 acquires setting information (described later) output by the controller control simulator 121 and causes the control-related information storage 134 to store the information. The information manager 123 reads these pieces of information stored in the information storage 130 in response to a request from the machine operation simulator 122.

The controller control simulator 121 executes the controller program to simulate control performed by the controller 20. The controller control simulator 121 first reads, through the information manager 123, the controller program stored in the controller program storage 131 and the setting value for the control calculation cycle stored in the parameter storage 132. The controller control simulator 121 then executes the controller program using the setting value for the control calculation cycle as one control calculation cycle. The controller control simulator 121 calculates the setting value for the control performed by the controller 20 and outputs setting information indicating the setting value to the information manager 123. The setting value for the control performed by the controller 20 is, for example, a value indicating a positioning address or a positioning speed used by the simulator.

The machine operation simulator 122 simulates the operation of the machine 10 using the machine model 140. The machine operation simulator 122 first reads, through the information manager 123, information about the machine model 140 and allocation stored in the machine model storage 133, the setting value for the operation calculation cycle stored in the parameter storage 132, and the setting information stored in the control-related information storage 134. The machine operation simulator 122 simulates the operation of the machine 10 using the machine model 140 with the setting value for the operation calculation cycle used as one calculation cycle.

### Simulation of Operation of Machine 10 in Embodiment 1

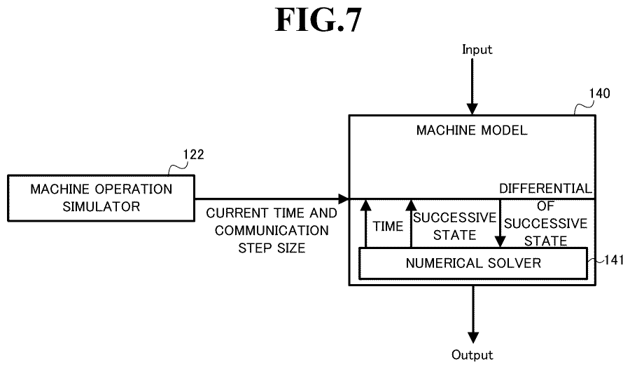

The machine model 140 outputs, upon a request for an elapse of a specific time, information indicating the state of the machine 10 at a time at which the specific time elapses from the current time. More specifically, as illustrated in FIG. 7, the machine model 140 includes a numerical solver 141 that can solve, through numerical calculation, a series of ordinary differential equations representing the operation of the model of the machine 10. The numerical solver 141 is a processor that inputs values indicating time and the successive state into the machine model 140 to acquire the differential value of the successive state from the machine model 140 as an output.

The machine operation simulator 122 first specifies, for the machine model 140, the current time and a communication step size that is a time interval from the current time. The communication step size is a setting value for the operation calculation cycle. The machine operation simulator 122 inputs the input value that is set based on the information about allocation and the setting information into the machine model 140. The input value includes, for example, a value indicated by the axis variable with the data name Axis0001.Md.SetPosition. The numerical solver 141 inputs the current time, the time based on the communication step size, and the value indicating the successive state of the machine 10 based on the input value into the machine model 140 to acquire the differential value of the successive state as an output. The machine model 140 outputs the output value based on the differential value of the successive state to the machine operation simulator 122. The output value includes, for example, a value indicated by the axis variable with the data name Axis0001.Md.ActualPosition.

The machine operation simulator 122 can thus simulate the operation of the machine 10 using the machine model 140 with the setting value for the operation calculation cycle used as one calculation cycle, or more specifically, as a communication step size. As described above, the setting value for the operation calculation cycle is the same as the setting value for the control calculation cycle. Thus, the simulation of the operation of the machine 10 performed by the machine operation simulator 122 can be synchronized with the simulation of the control of the controller 20 performed by the controller control simulator 121.

The machine operation simulator 122 causes, through the information manager 123, the control-related information storage 134 to store the simulation result information indicating the output value. The simulator communication interface 115 can thus acquire simulation result information by reading the simulation result information stored in the control-related information storage 134.

### Process of Outputting Simulation Results in Embodiment 1

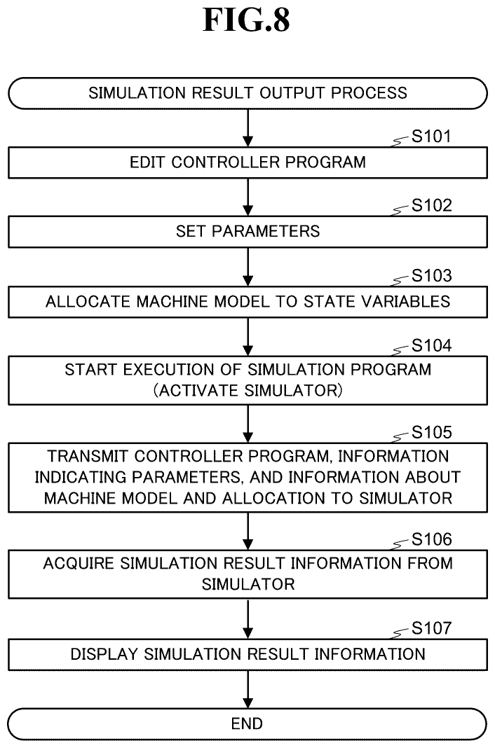

Referring to a flowchart, the operation of outputting the simulation result information about the controller program edited by the engineering setting tool 100 is described. The engineering setting tool 100 starts the process of outputting a simulation result illustrated in FIG. 8 upon activation of the engineering setting tool program 110.

The controller program editor 111 first displays a program editing screen (not illustrated) and edits the source code of the controller program based on a user input into the program editing screen with the operation unit 54 (step S101). The parameter setter 112 then displays a parameter setting screen (not illustrated) and sets parameters such as the setting value for the control calculation cycle and the setting value for the operation calculation cycle based on user inputs into the program setting screen with the operation unit 54 (step S102).

The machine model allocator 114 then displays the machine model allocation screen 200 illustrated in FIGS. 4 to 6, and allocates the machine model 140 to the state variables such as the axis variable or the axis group variable based on user inputs into the machine model allocation screen 200 with the operation unit 54 (step S103). For example, the machine model allocator 114 sets an input and an output to and from the machine model 140 through user inputs into the state variable setting screen 210, the machine model input-output setting screen 220, and the input-output setting support screen 230 included in the machine model allocation screen 200. More specifically, the machine model allocator 114 sets the axis variable with the data name Axis0001.Md.SetPosition as an input into the machine model 140 and the axis variable with the data name Axis0001.Md.ActualPosition as an output from the machine model 140.

The simulator communication interface 115 then starts execution of the simulation program 120 to activate the simulator (step S104). The simulator communication interface 115 then transmits the controller program, information indicating the parameters, and information about the machine model 140 and allocation to the simulator (step S105). The simulator communication interface 115 then acquires the simulation result information stored in the information storage 130 from the simulator (step 106). The controller program outputter 117 displays the simulation result information (not illustrated) (step S107) and ends the process.

The engineering setting tool 100 acquires the machine model 140 simply with the machine model acquirer 113 receiving, from a device external to the user system 1, the machine model 140 generated by the external device. This operation is thus not described in detail with reference to a flowchart.

### Simulation in Embodiment 1

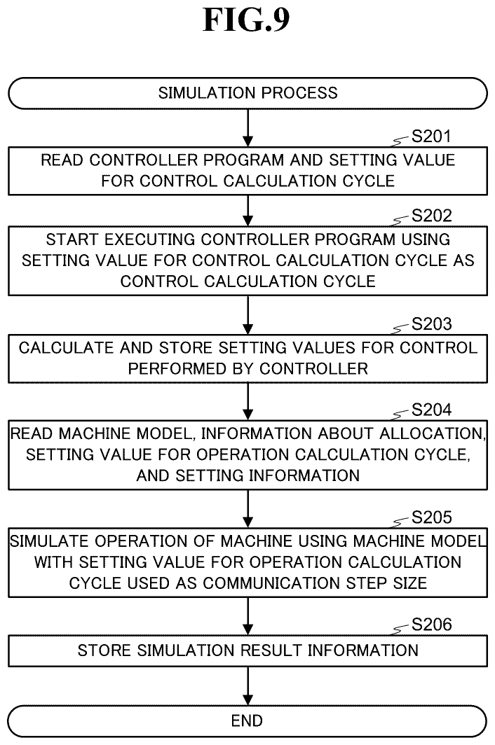

Referring to a flowchart, the operation of the engineering setting tool 100 to simulate the control performed by the controller 20 on the operation of the machine 10 based on the controller program is now described. When the simulator communication interface 115 activates the simulator by starting execution of the simulation program 120, the engineering setting tool 100 starts performing the simulation illustrated in FIG. 9.

The controller control simulator 121 first reads, through the information manager 123, the controller program and the setting value for the control calculation cycle stored in the information storage 130 (step S201). The controller control simulator 121 then starts executing the controller program using the setting value for the control calculation cycle as one control calculation cycle (step S202). The controller control simulator 121 then calculates setting values for the control performed by the controller 20, such as a value indicating the positioning address and a value indicating the positioning speed, and causes, through the information manager 123, the control-related information storage 134 to store the setting information indicating the setting values (step S203).

The machine operation simulator 122 then reads, through the information manager 123, information stored in the information storage 130, such as the machine model 140, the information about allocation, the setting value for the operation calculation cycle, and the setting information (step S204). The machine operation simulator 122 then simulates the operation of the machine 10 using the machine model 140 with the setting value for the operation calculation cycle used as the communication step size, or more specifically, as one calculation cycle (step S205). For example, the machine operation simulator 122 specifies the current time and the communication step size for the machine model 140 and inputs an input value including the value indicated by the axis variable Axis0001.Md.SetPosition set based on the information about allocation and the setting information. The machine operation simulator 122 then acquires an output value including a value indicated by the axis variable

Axis0001.Md.ActualPosition based on the differential value of the successive state output by the machine model 140. The machine operation simulator 122 then causes, through the information manager 123, the control-related information storage 134 to store the simulation result information (step S206) and ends the process.

The information manager 123 causes the information storage 130 to store information transmitted from the simulator communication interface 115 simply by causing each of the storages 131 to 133 in the information storage 130 to store the received information. Thus, the above operation performed by the information manager 123 is not described in detail with reference to a flowchart.

As described above, in the user system 1 in the present embodiment, the simulation program 120 is installed on the engineering setting tool 100. The engineering setting tool 100 thus executes the simulation program 120 to function as the simulator, or more specifically, a simulation device that simulates the control on the machine 10 performed by the controller 20.

In the user system 1 in the present embodiment, the controller control simulator 121 in the engineering setting tool 100 executes the controller program to simulate the control performed by the controller 20. The machine operation simulator 122 in the engineering setting tool 100 simulates the operation of the machine 10 with the machine model 140. The machine model 140 is a model in a library file format acquired from an external device by the machine model acquirer 113.

The simulation program 120 according to the present embodiment can thus simulate the control performed by the controller 20 and the operation of the machine 10 without relying on a device that generates a model of the machine 10 controlled by the controller 20.

In the user system 1 in the present embodiment, the controller control simulator 121 in the engineering setting tool 100 executes the controller program to calculate setting values for the control performed by the controller 20, such as the value indicating the positioning address or the value indicating the positioning speed. The controller control simulator 121 causes, through the information manager 123, the control-related information storage 134 to store the setting information indicating the calculated setting values. The machine operation simulator 122 then reads the setting information through the information manager 123.

The controller control simulator 121 and the machine operation simulator 122 can thus transmit and receive information through the information manager 123. The engineering setting tool 100 thus allows the machine operation simulator 122 to simulate the operation of the machine 10 using the setting values for the control performed by the controller 20 calculated by the controller control simulator 121 executing the controller program. Thus, the simulation program 120 according to the present embodiment can verify the entire user system 1 including the operation of the machine 10 using the controller program actually executed by the controller 20 in the user system 1.

In the user system 1 in the present embodiment, upon a request for an elapse of a specific time, the machine model 140 outputs, as an output value, information indicating the value of the axis variable of the machine 10 at a time at which the specific time elapses from the current time. The machine operation simulator 122 in the engineering setting tool 100 specifies the current time and the communication step size for the machine model 140 and inputs an input value that is set based on the information about allocation and the setting information. The machine operation simulator 122 can thus acquire an output value based on the differential value of the successive state output by the machine model 140 and simulate the operation of the machine 10.

The communication step size specified by the machine operation simulator 122 is a setting value for the operation calculation cycle set by the parameter setter 112. The parameter setter 112 automatically sets the setting value for the operation calculation cycle at the same value as the setting value for the control calculation cycle. The communication step size specified by the machine operation simulator 122 is thus has the same time length as the control calculation cycle in which the controller control simulator 121 executes the controller program.

In the manner described above, the simulation program 120 according to the present embodiment can synchronize the simulation of the control of the controller 20 performed by the controller control simulator 121 and the simulation of the operation of the machine 10 performed by the machine operation simulator 122.

The machine model 140 may set an internal calculation cycle in the model different from the communication step size. In this case, when the communication step size is set to be an integral multiple of the internal calculation cycle of the machine model 140, the simulation program 120 according to the present embodiment further improves the accuracy of the calculation performed by the machine model 140, as compared with when the communication step size is not set to such a value.

In the user system 1 in the present embodiment, the machine model allocator 114 in the engineering setting tool 100 allocates the machine model 140 to the state variable such as the axis variable or the axis group variable of the axis for the operation of the machine 10.

The engineering setting tool 100 according to the present embodiment can thus associate the state variables with the machine model 140 more easily than an engineering setting tool not including a machine model allocator, thus reducing the workload of the user verifying the user system 1 with the simulation program 120.

In particular, in the user system 1 in the present embodiment, the machine model allocator 114 in the engineering setting tool 100 allocates the machine model 140 to the state variable based on a user input into the machine model allocation screen 200 with the operation unit 54.

The user can thus visually perform the allocation described above. The engineering setting tool 100 according to the present embodiment can thus associate the state variables with the machine model 140 more easily than an engineering setting tool that does not allow allocation using the machine model allocation screen. The engineering setting tool 100 according to the present embodiment can thus reduce the workload of the operator verifying the user system 1 using the simulation program 120.

### Embodiment 2

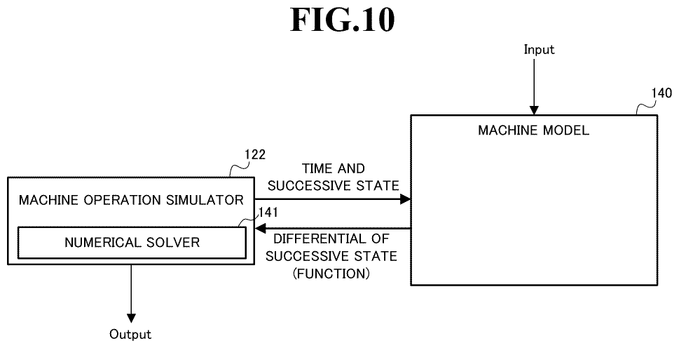

In Embodiment 1, the machine model 140 includes the numerical solver 141, but may not include the numerical solver 141. A user system 1 in Embodiment 2 is described in detail below with reference to FIG. 10. In Embodiment 2, the components different from the components in Embodiment 1 are described, without the same components as in Embodiment 1 being described to avoid redundancy.

### Simulation of Operation of Machine 10 in Embodiment 2

As illustrated in FIG. 10, a machine model 140 in Embodiment 2 does not include the numerical solver 141. The numerical solver 141 is included in the machine operation simulator 122. The machine model 140 in the present embodiment can output information indicating the time differential value of the state variable of the machine 10 at a specific time. More specifically, the machine model 140 can cause the numerical solver 141 to calculate the output value by providing, to the numerical solver 141, the function for acquiring an output value from an input value based on the time specified by the machine operation simulator 122 and the value indicating the successive state. The output value is the time differential value of the state variable of the machine 10 at the specific time.

In the present embodiment, the machine operation simulator 122 first determines a time step in which the numerical solver 141 is used, and a method for calculating the time differential value of the state variable in a subsequent time step. The machine operation simulator 122 determines the time step based on the setting value for the operation calculation cycle, or more specifically, determines the time step in which an integration step that is a time interval between successive time steps is the setting value for the operation calculation cycle. The numerical solver 141 specifies, for the machine model 140, the current time and the time based on the time step, and the value indicating the successive state based on the input value to acquire the above function. The numerical solver 141 calculates the output value from the input value using the acquired function and outputs the output value.

The machine operation simulator 122 can thus simulate the operation of the machine 10 using the machine model 140 with the setting value for the operation calculation cycle used as one calculation cycle, or more specifically, as an integration step. As described above, the setting value for the operation calculation cycle is the same as the setting value for the control calculation cycle. Thus, the simulation of the operation of the machine 10 performed by the machine operation simulator 122 can be synchronized with the simulation of the control of the controller 20 performed by the controller control simulator 121.

In the user system 1 in the present embodiment, as described above, the machine operation simulator 122 in the engineering setting tool 100 includes the numerical solver 141 and determines a time step in which the numerical solver 141 is used and a method for calculating the time differential value of the state variable in the subsequent time step. The machine model 140 outputs information indicating the time differential value of the state variable of the machine 10 at a specific time. When the numerical solver 141 specifies the values indicating the time and the successive state, the machine model 140 provides the function for acquiring an output value from an input value to the numerical solver 141. The numerical solver 141 can thus calculate the output value from the input value using the acquired function and output the output value. The machine operation simulator 122 can simulate the operation of the machine 10.

The integration step specified by the machine operation simulator 122 is a setting value for the operation calculation cycle set by the parameter setter 112. The parameter setter 112 automatically sets the setting value for the operation calculation cycle to the same value as the setting value for the control calculation cycle. The integration step set by the machine operation simulator 122 is thus has the same time as the control calculation cycle in which the controller control simulator 121 executes the controller program.

In the manner described above, the simulation program 120 according to the present embodiment can synchronize the simulation of the control of the controller 20 performed by the controller control simulator 121 and the simulation of the operation of the machine 10 performed by the machine operation simulator 122.

The simulation program 120 according to the present embodiment has the same operational effects as the simulation program 120 according to Embodiment 1.

### Embodiment 3

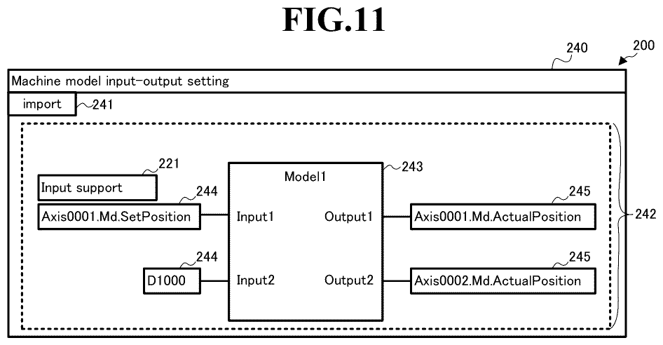

In Embodiment 1, the machine model input-output setting screen 240 includes the input-output setting section 222 in a table form, but the input-output setting section 222 may be in a format other than a table format to allow setting of inputs or outputs into or from the machine model 140. With reference to FIG. 11, a user system 1 in Embodiment 3 is described below in detail. In Embodiment 3, the components different from the components in Embodiment 1 are described, without the same components as in Embodiment 1 being described to avoid redundancy.

### Details of Functional Components of Engineering Setting Tool 100 According to Embodiment 3

A machine model allocation screen 200 in Embodiment 3 includes a machine model input-output setting screen 240 illustrated in FIG. 11, in place of the machine model input-output setting screen 240 illustrated in FIG. 5. In the present embodiment, in the state in FIG. 4, when the user presses the setting button 216 on the input-output setting section 215 through an input with the operation unit 54, the machine model allocator 114 displays the machine model input-output setting screen 240 illustrated in FIG. 10.

As illustrated in FIG. 11, the machine model input-output setting screen 240 includes, in an upper portion, an import button 241 to be pressed by the user and an input-output setter 242 in a block form in a lower portion.

The input-output setter 242 includes a machine model display 243 that displays the machine model 140 as a function. The input-output setter 242 further includes input displays 244 that display the set axis variables or the set axis group variables as inputs into the machine model 140 and output displays 245 that display the set axis variables or the set axis group variables as outputs from the machine model 140. The input displays 244 and the output displays 245 being displayed are connected to the machine model display 243. The input-output setter 242 includes the same input support button 221 as in Embodiment 1 or 2 in an upper portion.

The input-output setter 242 displays, for example, Axis0001.Md.SetPosition as an input into Input1 in the machine model 140 that is Model001. The input-output setter 242 displays, for example, Axis0001.Md.ActualPosition as an output from Output1 in the machine model 140 that is Model001.

The user first presses the import button 241 through an input with the operation unit 54 to display a machine model selection screen (not illustrated). In this state, when the user selects the machine model 140 with the operation unit 54, the machine model allocator 114 ends displaying the machine model selection screen and causes the machine model display 243 to display the selected machine model 140. The user can set inputs into and outputs from the machine model 140 with the input displays 244 and the output displays 245 through inputs with the operation unit 54. When the user presses the input support button 221 with any input or any output on the input displays 244 or the output display 245 being selected through an input with the operation unit 54, the machine model allocator 114 displays the input-output setting support screen 230 illustrated in FIG. 6.

When the user selects the data name of the axis variable or the axis group variable in the input-output setting support screen 230 through an input with the operation unit 54, the machine model allocator 114 ends displaying the input-output setting support screen 230, and automatically displays the data name of the selected axis variable or axis group variable on the input display 244 or the output display 245 for the input or the output selected in the machine model input-output setting screen 240 illustrated in FIG. 11.

In a specific example, the user presses the input support button 221 with the input display 244 for the input into Input1 being selected in the input-output setter 242 in the machine model input-output setting screen 240 illustrated in FIG. 5, and selects, for example, Axis0001 in the axis name selection section 231 in the input-output setting support screen 230 illustrated in FIG. 6, Monitor data in the structure type selection section 232, and *.Md.SetPosition in the data name selection section 233. In this case, the machine model allocator 114 automatically displays Axis0001.Md.SetPosition in the data name selection section 233 for the input into Input1 in the input-output setter 242 in the machine model input-output setting screen 240 illustrated in FIG. 11 to automatically set the axis variable or the axis group variable. The machine model allocator 114 can thus allocate the machine model 140 to the axis variable or the axis group variable. In the user system 1 in the present embodiment, as described above, the machine model input-output setting screen 240 in the engineering setting tool 100 includes the input-output setter 242 in the block form.

The engineering setting tool 100 according to the present embodiment can thus associate the state variables with the machine model 140 more easily than an engineering setting tool that does not perform allocation using the input-output setter in a block form. The engineering setting tool 100 according to the present embodiment can reduce the workload of the operator verifying the user system 1 using the simulation program 120.

The simulation program 120 according to the present embodiment has the same operational effects as the simulation program 120 according to Embodiment 1.

### Modification

In each of Embodiments 1 to 3, the engineering setting tool 100 is implemented by the simulation program 120 installed on a computer. In some embodiments, the engineering setting tool 100 may be implemented in, for example, a web application form. More specifically, the engineering setting tool 100 as a client may request, through a web browser, a web server that can implement the function of the simulation program 120 to perform processing as a simulator. This may cause the web server to perform the simulation.

The main portion of the engineering setting tool 100 including the control unit 51, the main storage 52, the external storage 53, the operation unit 54, the transmitter-receiver 56, and the internal bus 50 may be implemented by the programs 110 and 120 for performing the above operations. The programs 110 and 120 may be stored in a non-transitory recording medium readable by the engineering setting tool 100 such as a flash memory for distribution and may be installed to implement the engineering setting tool 100 that performs the above processing. In some embodiments, a storage device included in a server device on a communication network such as a local area network (LAN) or the Internet may store the programs 110 and 120, and the engineering setting tool 100 may download the programs 110 and 120 to implement the engineering setting tool 100.

In the system with the above functions of the engineering setting tool 100 implementable partially by the OS and partially by an application program or through cooperation between the OS and the application program, portions executable by the application program other than the OS may be stored in a non-transitory recording medium or a storage device.

The programs may be superimposed on a carrier wave to be provided through a communication network. For example, the programs may be posted on a bulletin board system (BBS) on the network to be provided through the network. The programs may be activated and executed under the control performed by the OS in the same manner as another application program to perform the above processing.

The foregoing describes some example embodiments for explanatory purposes. Although the foregoing discussion has presented specific embodiments, persons skilled in the art will recognize that changes may be made in form and detail without departing from the broader spirit and scope of the invention. Accordingly, the specification and drawings are to be regarded in an illustrative rather than a restrictive sense. This detailed description, therefore, is not to be taken in a limiting sense, and the scope of the invention is defined only by the included claims, along with the full range of equivalents to which such claims are entitled.

### REFERENCE SIGNS LIST

1 User system
10 Machine
11 Motor
12 Motor driver
20 Controller
50 Internal bus
51 Control unit
52 Main storage
53 External storage
54 Operation unit
56 Transmitter-receiver
59 Control program
100 Engineering setting tool
110 Engineering setting tool program
111 Controller program editor
112 Parameter setter
113 Machine model acquirer
114 Machine model allocator
115 Simulator communication interface
116 Simulation result outputter
117 Controller program outputter
120 Simulation program
121 Controller control simulator
122 Machine operation simulator
123 Information manager
130 Information storage
131 Controller program storage
132 Parameter storage
133 Machine model storage
134 Control-related information storage
135 Simulation program storage
140 Machine model
141 Numerical solver
200 Machine model allocation screen
210 State variable setting screen
211 Axis name display section
212 Member display section
213 Validity setting section
214 File path setting section
215 Input-output setting section
216 Setting button
220, 240 Machine model input-output setting screen
221 Input support button
222 Input-output setting section
230 Input-output setting support screen
231 Axis name selection section
232 Structure type selection section
233 Data name selection section
241 Import button
242 Input-output setter
243 Machine model display
244 Input display
245 Output display

1. A non-transitory computer-readable recording medium storing a simulation program, the simulation program causing a simulation device for simulating control on a machine performed by a controller to execute processing of:
simulating control performed by the controller by executing a program for the controller; and
simulating an operation of the machine using a machine model being a model of the machine made in a library file format by an external generation device that is independent of a system for controlling the machine by the controller and being acquired from an external transmission device that is independent of the system.

2. The non-transitory computer-readable recording medium according to claim 1, wherein
the machine model outputs, upon a request for an elapse of a specific time, information indicating a state of the machine at a time at which the specific time elapses from a current time, and
a communication step size has a same time length as a calculation cycle in which the controller performs control, the communication step size being a time interval from when the simulation device starts reading information output from the machine model to when the simulation device starts reading information output subsequently.

3. The non-transitory computer-readable recording medium according to claim 1, wherein
the machine model outputs information indicating a value of time differentiation of a state variable of the machine at a specific time, and
an integration step has a same time length as a calculation cycle in which the controller performs control, the integration step being a time interval from a time step in which the machine model performs the time differentiation to a subsequent time step.

4. The non-transitory computer-readable recording medium according to claim 1, further causing the simulation device to execute processing of:
allocating the machine model to a state variable of the machine used in the program for the controller.

5. A simulation device for simulating control on a machine performed by a controller, the simulation device comprising:
processing circuitry; and
a transmitter-receiver, wherein
the processing circuitry simulates control performed by the controller by executing a program for the controller,
the transmitter-receiver acquires, from an external transmission device, a machine model being a model of the machine made in a library file format by an external generation device that is independent of a system for controlling the machine by the controller, the external transmission device being independent of the system, and
the processing circuitry simulates an operation of the machine using the machine model.

6. A controlling method comprising:
simulating control performed by a controller by executing a program for the controller; and
simulating an operation of a machine using a machine model being a model of the machine made in a library file format by an external generation device that is independent of a system for controlling the machine by the controller and being acquired from an external transmission device that is independent of the system.

7. The non-transitory computer-readable recording medium according to claim 1, wherein
the external transmission device and the external generation device are different devices.

8. The simulation device according to claim 5, wherein
the machine model outputs, upon a request for an elapse of a specific time, information indicating a state of the machine at a time at which the specific time elapses from a current time, and
a communication step size has a same time length as a calculation cycle in which the controller performs control, the communication step size being a time interval from when the processing circuitry starts reading information output from the machine model to when the processing circuitry starts reading information output subsequently.

9. The simulation device according to claim 5, wherein
the machine model outputs information indicating a value of time differentiation of a state variable of the machine at a specific time, and
an integration step has a same time length as a calculation cycle in which the controller performs control, the integration step being a time interval from a time step in which the machine model performs the time differentiation to a subsequent time step.

10. The simulation device according to claim 5, wherein
the processing circuitry allocates the machine model to a state variable of the machine used in the program for the controller.

11. The simulation device according to claim 5, wherein
the external transmission device and the external generation device are different devices.

12. The controlling method according to claim 6, wherein
the machine model outputs, upon a request for an elapse of a specific time, information indicating a state of the machine at a time at which the specific time elapses from a current time, and
a communication step size has a same time length as a calculation cycle in which the controller performs control, the communication step size being a time interval from when reading of information output from the machine model is started to when reading of information output subsequently is started.

13. The controlling method according to claim 6, wherein
the machine model outputs information indicating a value of time differentiation of a state variable of the machine at a specific time, and
an integration step has a same time length as a calculation cycle in which the controller performs control, the integration step being a time interval from a time step in which the machine model performs the time differentiation to a subsequent time step.

14. The controlling method according to claim 6, wherein
the machine model is allocated to a state variable of the machine used in the program for the controller.

15. The controlling method according to claim 6, wherein
the external transmission device and the external generation device are different devices.
